(19) United States
(12) Patent Application Publication
(10) Pub. No.: US 2021/0041772 A1
(43) Pub. Date: Feb. 11, 2021

(54) METHOD FOR SUPPRESSING VIBRATION OF GIMBAL, AND GIMBAL

(71) Applicant: SZ DJI TECHNOLOGY CO., LTD., Shenzhen (CN)

(72) Inventors: Wenlin XIE, Shenzhen (CN); Zihan CHEN, Shenzhen (CN); Paul PAN, Shenzhen (CN)

(21) Appl. No.: 16/988,688

(22) Filed: Aug. 9, 2020

Related U.S. Application Data
(63) Continuation of application No. PCT/CN2018/076040, filed on Feb. 9, 2018.

(51) Int. Cl. G03B 17/56; G03B 15/00; G03B 11/00; G01H 1/00; F16F 15/00

(52) U.S. Cl. CPC G03B 17/561; G03B 15/006; B64C 39/024; G01H 1/003; F16F 15/002; G03B 11/00

(57) ABSTRACT

A method for suppressing a vibration of a gimbal includes obtaining state information of the gimbal, determining a vibration frequency of the gimbal according to the state information, and performing an operation of suppressing the vibration of the gimbal according to the vibration frequency of the gimbal.

### CROSS-REFERENCE TO RELATED APPLICATION

This application is a continuation of International Application No. PCT/CN2018/076040, filed on Feb. 9, 2018, the entire content of which is incorporated herein by reference.

### TECHNICAL FIELD

The present disclosure relates to the field of unmanned aerial vehicle (UAV) and, more particularly, to a method for suppressing vibration of gimbal and a gimbal.

### BACKGROUND

A gimbal is a device used to stabilize a payload (e.g., a photographing device). Generally, the gimbal can carry multiple payloads, for example, a plurality of payloads having different weights. When the gimbal carries different payloads, a user needs to set control parameters (e.g., sensitivity, dead zone, and the like) of the gimbal to cause the gimbal to reach a better working state.

However, setting the control parameters of the gimbal for different payloads requires a higher degree of professionalization of the user. Once the control parameters of the gimbal are not set properly, the gimbal generates vibration, which seriously affects the working state of the payloads.

### SUMMARY

In accordance with the disclosure, there is provided a method for suppressing a vibration of a gimbal including obtaining state information of the gimbal, determining a vibration frequency of the gimbal according to the state information, and performing an operation of suppressing the vibration of the gimbal according to the vibration frequency of the gimbal.

Also in accordance with the disclosure, there is provided a gimbal including a memory storing program instructions and a processor configured to execute the program instructions stored in the memory to obtain state information of the gimbal, determine a vibration frequency of the gimbal according to the state information, and perform an operation of suppressing a vibration of the gimbal according to the vibration frequency of the gimbal.

### BRIEF DESCRIPTION OF THE DRAWINGS

The drawings are intended to provide a clearer illustration of the present disclosure. The drawings used in the description of the disclosed embodiments are briefly described below. It will be appreciated that the described drawings are some examples of the present disclosure. Other drawings conceived by those having ordinary skills in the art on the basis of the described drawings without inventive efforts should fall within the scope of the present disclosure.

FIG. 1 is a schematic structural diagram of a gimbal consistent with embodiments of the disclosure.

FIG. 2 is a schematic flow chart of a method for suppressing vibration of gimbal consistent with embodiments of the disclosure.

FIG. 3 is a schematic flow chart of another method for suppressing vibration of gimbal consistent with embodiments of the disclosure.

FIG. 4 schematically shows an angular acceleration when a gimbal is in a stable state consistent with embodiments of the disclosure.

FIG. 5 schematically shows an angular acceleration when the gimbal generates vibration consistent with embodiments of the disclosure.

FIG. 6 schematically shows another angular acceleration when the gimbal generates vibration consistent with embodiments of the disclosure.

FIG. 7 schematically shows frequency domain data obtained by performing frequency domain transformation on the angular acceleration in FIG. 4 consistent with embodiments of the disclosure.

FIG. 8 schematically shows frequency domain data obtained by performing frequency domain transformation on the angular acceleration in FIG. 5 consistent with embodiments of the disclosure.

FIG. 9 schematically shows frequency domain data obtained by performing frequency domain transformation on the angular acceleration in FIG. 6 consistent with embodiments of the disclosure.

FIG. 10 is a schematic flow chart of another method for suppressing vibration of gimbal consistent with embodiments of the disclosure.

FIG. 11 is a schematic diagram of a gimbal control system consistent with embodiments of the disclosure.

FIG. 12 is a schematic flow chart of another method for suppressing vibration of gimbal consistent with embodiments of the disclosure.

FIG. 13 is a schematic diagram showing configuring a filter according to a vibration frequency of a gimbal consistent with embodiments of the disclosure.

FIG. 14 is a schematic flow chart of another method for suppressing vibration of gimbal consistent with embodiments of the disclosure.

FIG. 15 is a schematic flow chart of another method for suppressing vibration of gimbal consistent with embodiments of the disclosure.

FIG. 16 is a schematic structural diagram of another gimbal consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. Further, when a first component “obtains” data from a second component, the first component can directly communicate with the second component to obtain the data, or can obtain the data from the second component via another component.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Exemplary embodiments will be described with reference to the accompanying drawings. Unless conflicting, the exemplary embodiments and features in the exemplary embodiments can be combined with each other.

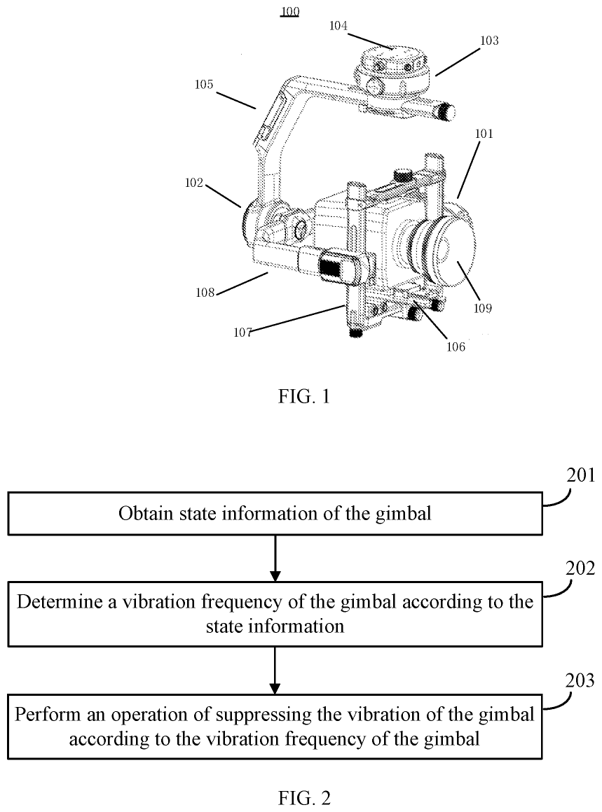

A gimbal refers to a device for stabilizing a payload, and the payload may include a photographing device. The gimbal can also adjust an operation direction of the payload, for example, the gimbal can adjust a photographing direction of the photographing device. The gimbal may include a handheld gimbal or a gimbal arranged at a movable platform. The movable platform may be an unmanned aerial vehicle (UAV), an unmanned vehicle, or the like. The gimbal can include a two-axis gimbal or a multi-axis gimbal. Herein, a three-axis gimbal is taken as an example for illustration. FIG. 1 is a schematic structural diagram of an example gimbal 100 consistent with the disclosure. For example, the gimbal 100 can be a handheld gimbal. As shown in FIG. 1, the gimbal 100 includes a pitch-axis driving motor 101, a roll-axis driving motor 102, a yaw-axis driving motor 103, a gimbal base 104, a yaw-axis arm 105, a photographing device fixing mechanism 106, a pitch-axis arm 107, and a roll-axis arm 108. The photographing device fixing mechanism 106 is arranged at the pitch-axis arm 107 and configured to fix the photographing device 109. The pitch-axis drive motor 101 can be configured to drive the photographing device 109 to rotate in a pitch direction, the roll-axis drive motor 102 can be configured to drive the photographing device 109 to rotate in a yaw direction, and the yaw-axis drive motor 103 can be configured to drive the photographing device 109 in a roll direction. The photographing device fixing mechanism 106 can include a gyroscope or an inertial measurement unit (IMU), and the gyroscope or IMU can be configured to detect an attitude of the photographing device 109. The attitude of the photographing device 109 can include an attitude of the gimbal. That is, a yaw attitude of the photographing device 29 can include a yaw attitude of the gimbal, a pitch attitude of the photographing device 109 can include a pitch attitude of the gimbal, and a roll attitude of the photographing device 109 can include a roll attitude of the gimbal.

In order to adapt the gimbal to different payloads or different operating environments, a user needs to set the control parameters of the gimbal. However, setting the control parameters of the gimbal for different payloads or different operating environments requires a higher degree of professionalism for the user. If the control parameters of the gimbal are not set properly, the gimbal can generate vibration, which can seriously affect a working state of the payload. For example, a jitter of an image captured by the photographing device can be caused, and a shooting quality of the photographing device can be reduced.

The present disclosure provides a method for suppressing vibration of gimbal. The vibration may include a self-excited vibration. FIG. 2 is a schematic flow chart of an example method for suppressing vibration of gimbal consistent with the disclosure. The method may be implemented by, e.g., the gimbal or a processor of the gimbal. The processor may include a dedicated processor or a general-purpose processor.

As shown in FIG. 2, at S201, state information of the gimbal is obtained. For example, the processor of the gimbal can obtain the state information of the gimbal via a sensor arranged at the gimbal. The state information may include any information associated with, for example, an attitude state of the gimbal, a joint angle state of the gimbal, a state of the gimbal (e.g., a state of an angular acceleration, a state of an angular velocity), and the like. The state information of the gimbal may include one or more of an angular acceleration, angular velocity, attitude information, and joint angle of the gimbal. The state information of the gimbal can include state information of the payload carried by the gimbal. The state information of the gimbal may include state information corresponding to one or more axes of the gimbal (e.g., one or more of a yaw axis, a pitch axis, and a roll axis).

In some embodiments, the state information of the gimbal can include the angular acceleration(s) of the gimbal. Obtaining the state information of the gimbal can include obtaining the joint angle(s) of the gimbal, and determining the angular acceleration(s) of the gimbal according to the joint angle(s). For example, each axis of the gimbal can arrange an angle sensor. The angle sensor may include at least one of a potentiometer, a Hall sensor, or a photoelectric encoder. The joint angle(s) corresponding to one or more axes of the gimbal can be obtained through the angle sensors, and the angular acceleration(s) corresponding to one or more axes of the gimbal can be determined according to the joint angle(s). For example, differential calculation can be performed on the determined joint angle(s) to obtain the angular acceleration(s) of the gimbal.

In some embodiments, the state information of the gimbal can include the angular acceleration(s) of the gimbal, and obtaining the state information of the gimbal can include obtaining the angular acceleration(s) of the gimbal according to a gyroscope arranged at the gimbal. For example, a gyroscope can be arranged at the gimbal. The processor of the gimbal can obtain a measured value of the gyroscope and determine the angular acceleration(s) of the gimbal according to the measured value.

At S202, a vibration frequency of the gimbal is determined according to the state information. When the gimbal generates vibration, the state information of the gimbal can reflect the vibration state of the gimbal. In order to accurately suppress the vibration of the gimbal, the vibration frequency of the gimbal can be determined. After the state information of the gimbal is obtained, the vibration frequency of the gimbal can be determined according to the state information of the gimbal.

At S203, an operation of suppressing the vibration of the gimbal is performed according to the vibration frequency of the gimbal. After the vibration frequency of the gimbal is determined, the vibration state of the gimbal can be roughly determined. The operation of suppressing the vibration of the gimbal can be performed according to the vibration frequency of the gimbal, so as to reduce the vibration of the gimbal at the vibration frequency and improve the working state of the gimbal.

Consistent with the disclosure, the vibration frequency of the gimbal can be determined by the state information of the gimbal, and the operation of suppressing the vibration of the gimbal can be performed according to the vibration frequency of the gimbal. As such, the gimbal can perform the operation of suppressing the vibration according to its own vibration frequency. It does not require the user to manually adjust the control parameters of the gimbal, thereby reducing the professional requirements of the user for the gimbal operation and improving the working state of the gimbal.

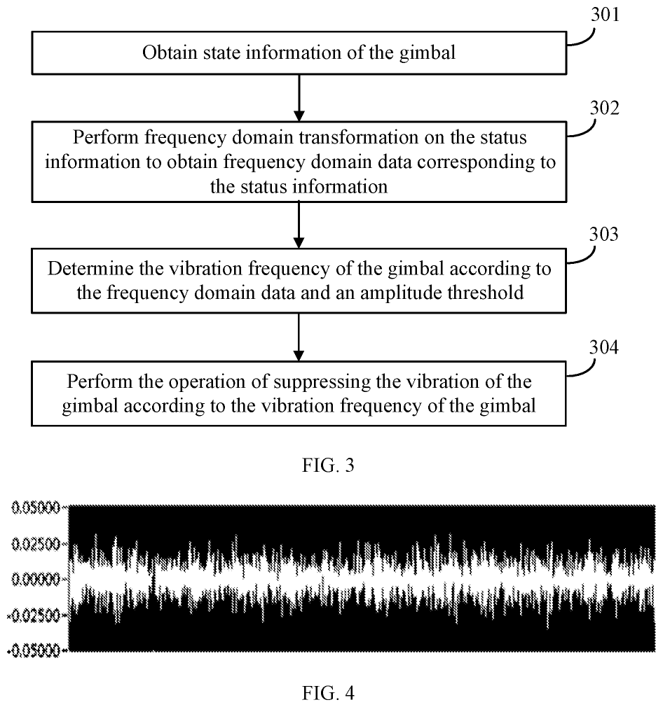

FIG. 3 is a schematic flow chart of another example method for suppressing vibration of gimbal consistent with the disclosure. As shown in FIG. 3, at S301, the state information of the gimbal is obtained. The implementation of the process at S301 is similar to the implementation of the process at S201, and detailed description thereof is omitted herein.

At S302, frequency domain transformation is performed on the state information to obtain frequency domain data corresponding to the state information. After obtaining the state information of the gimbal, the state information in the time domain may be transformed into the frequency domain to obtain the frequency domain data corresponding to the state information. The frequency domain transformation can include any transformation that transforms the state information in the time domain into frequency domain data, for example, a Fourier transform, a Laplace transform, or the like. The frequency domain data may include amplitude values obtained by performing the frequency domain transformation on the state information and frequencies corresponding to the amplitude value. The frequency domain data may represent an energy distribution when the gimbal is vibrating.

At S303, the vibration frequency of the gimbal is determined according to the frequency domain data and an amplitude threshold. The frequency domain data may include the amplitude values obtained by performing the frequency domain transformation on the state information and the frequencies corresponding to the amplitude values. The amplitude values in the frequency domain data can be compared with the amplitude threshold to obtain a comparison result. According to the comparison result, the vibration frequency of the gimbal can be determined. That is, the frequency or frequency band at which the gimbal vibrates can be determined.

In some embodiment, determining the vibration frequency of the gimbal according to the frequency domain data and the amplitude threshold can include determining an amplitude greater than or equal to the amplitude threshold in the frequency domain data, and determining the frequency corresponding to the amplitude as the vibration frequency of the gimbal.

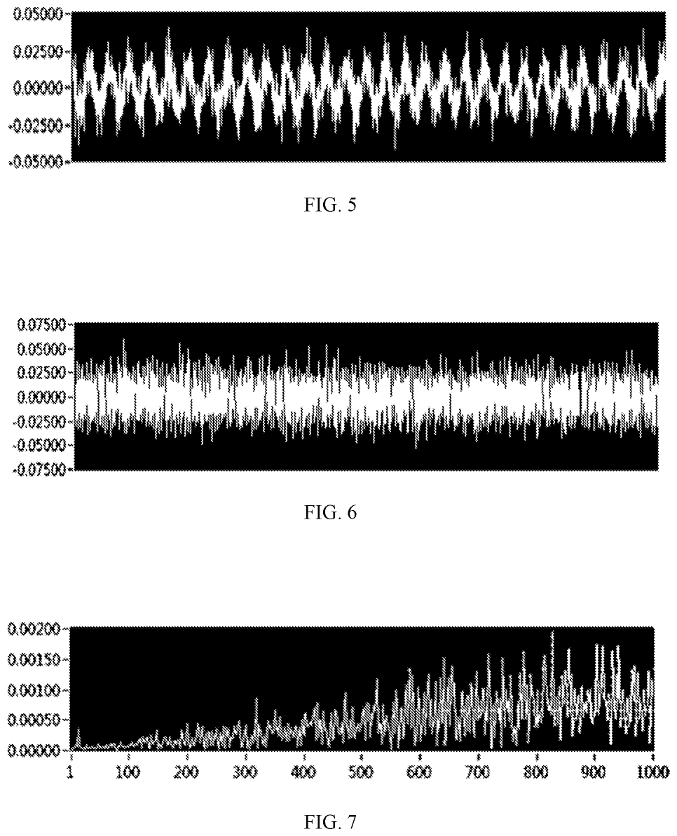

For the simplification of description, the angular acceleration is taken as an example of the state information for illustration. FIG. 4 schematically shows an example angular acceleration when the gimbal is in a stable state consistent with the disclosure. As shown in FIG. 4, when the gimbal is in the stable state, the angular acceleration of the gimbal can be approximately stable at a state where the angular acceleration is zero. FIG. 5 schematically shows an example angular acceleration when the gimbal generates vibration consistent with the disclosure. FIG. 6 schematically shows another example angular acceleration when the gimbal generates vibration consistent with the disclosure. As shown in FIGS. 5 and 6, when the gimbal vibrates, more obvious jitter appears in the angular acceleration of the gimbal. A jitter frequency of the angular acceleration of the gimbal in FIG. 6 is significantly higher than that of the angular acceleration of the gimbal in FIG. 5. According to the analysis, the angular acceleration of the gimbal in stable state and the angular acceleration of the gimbal during vibration show different characteristics.

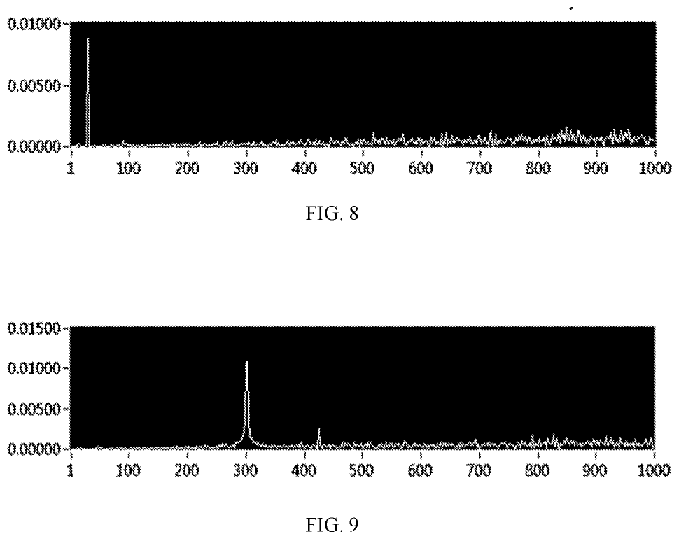

After obtaining the angular acceleration, the processor of the gimbal can perform the frequency domain transformation on the angular acceleration to obtain the frequency domain data corresponding to the angular acceleration. FIG. 7 schematically shows the frequency domain data obtained by performing the frequency domain transformation on the angular acceleration in FIG. 4. The frequency domain transformation can be performed on the angular acceleration shown in FIG. 4 to obtain spectral data shown in FIG. 7. As shown in FIG. 7, when the gimbal is stable, the amplitudes in the spectrum data are small. FIG. 8 schematically shows the frequency domain data obtained by performing the frequency domain transformation on the angular acceleration in FIG. 5. When the gimbal generates vibration, the frequency domain transformation can be performed on the angular acceleration shown in FIG. 5 to obtain spectral data shown in FIG. 8. As shown in FIG. 8, a sharp peak appears around a center frequency of about 15 Hz, and the amplitude of the peak is relatively large. FIG. 9 schematically shows the frequency domain data obtained by performing the frequency domain transformation on the angular acceleration in FIG. 6. The frequency domain transformation can be performed on the angular acceleration shown in FIG. 6 to obtain spectral data shown in FIG. 9. As shown in FIG. 9, a sharp peak appears around a center frequency of about 300 Hz, and the amplitude of the peak is relatively large. According to the analysis, when the gimbal generates vibration, some frequencies in the frequency domain data or a certain frequency band can have the large amplitudes. Therefore, the amplitude threshold can be set and the amplitudes in the frequency domain data can be compared with the amplitude threshold. When the amplitude in the frequency domain data is greater than or equal to the amplitude threshold, it can be determined that the frequency corresponding to the amplitude is the vibration frequency of gimbal.

In some embodiments, the amplitude threshold can be determined according to the frequency band. The amplitude threshold may be associated with the frequency band, i.e., the amplitude thresholds corresponding to different frequency bands may be different. For example, the amplitude threshold can be 0.00500 in the frequency band of 0 to 100 Hz, the amplitude threshold can be 0.00650 in the frequency band of 100 to 500 Hz, and the amplitude threshold can be 0.00800 in the frequency band of 500 to 1000 Hz. The amplitudes of different frequency bands in the frequency domain data can be compared with the amplitude threshold in the corresponding frequency band, the amplitude in the frequency domain data that are greater than or equal to the amplitude thresholds can be determined, and the frequency corresponding to the amplitude can be determined as the vibration frequency.

In some embodiments, the amplitude threshold can be determined according to an inertia moment of the payload carried by the gimbal. The amplitude threshold can be associated with the payload carried by the gimbal, i.e., the amplitude thresholds corresponding to different inertia moments can be different. In some embodiments, the magnitude threshold can be linearly related to the inertia moment of the payload. In some embodiments, for a same gimbal, the inertia moment of the payload carried by the gimbal can be related to a mass of the payload. For example, when the mass of the payload is 1 kg, the amplitude threshold may be 0.00200, when the mass of the payload is 2 kg, the amplitude threshold may be 0.00400, and when the mass of the payload is 3 kg, the amplitude threshold may be 0.00600.

It can be appreciated that the amplitude threshold can be determined according to the frequency band and the inertia moment of the payload carried by the gimbal. The amplitude threshold may be associated with the frequency band and the payload carried by the gimbal, i.e., the amplitude thresholds corresponding to different inertia moments and different frequency bands may be different.

At S304, the operation of suppressing the vibration of the gimbal is performed according to the vibration frequency of the gimbal. The implementation of the process at S304 is similar to the implementation of the process at S203, and detailed description thereof is omitted herein.

Consistent with the disclosure, with the state information converted into the corresponding frequency domain data, the vibration frequency of the gimbal can be accurately determined based on the frequency domain data and the amplitude threshold. The gimbal can perform the operation of suppressing the vibration according to the vibration frequency. It does not require the user to manually adjust the control parameters of the gimbal, thereby reducing the professional requirements of the user on the gimbal operation and improving the working state of the gimbal.

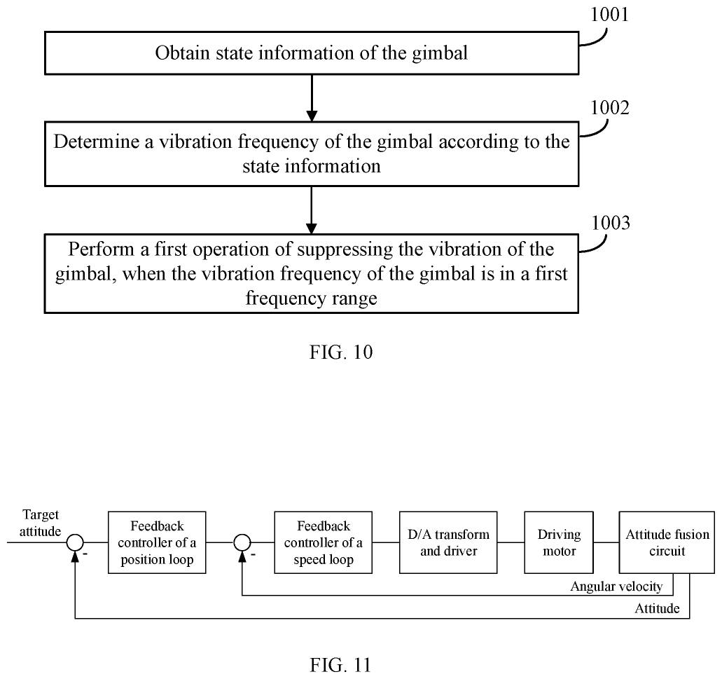

FIG. 10 is a schematic flow chart of another example method for suppressing vibration of gimbal consistent with the disclosure. As shown in FIG. 10, at S1001, the state information of the gimbal is obtained. The implementation of the process at S1001 is similar to the implementation of the process at S201, and detailed description thereof is omitted herein.

At S1002, the vibration frequency of the gimbal is determined according to the state information. The implementation of the process at S1002 is similar to the implementation of the process at S202, or the processes at S302 and S303, and detailed description thereof is omitted herein.

At S1003, when the vibration frequency of the gimbal is in a first frequency range, a first operation of suppressing the vibration of the gimbal is performed. After determining the vibration frequency of the gimbal, the processor of the gimbal can determine whether the vibration frequency is in the first frequency range, i.e., determine whether the vibration frequency is in a first frequency band. When the vibration frequency is determined to be in the first frequency range, an operation corresponding to the first frequency range to suppress the vibration of the gimbal can be performed, i.e., the first operation. In some embodiments, the first frequency range may be defined as a low frequency band in the working frequency of the gimbal. When the vibration frequency of the gimbal is in the first frequency range, performing the first operation of suppressing the vibration of the gimbal may include, when the vibration frequency of the gimbal is less than or equal to a first frequency threshold, performing the first operation of suppressing the vibration of the gimbal.

In some embodiments, performing the first operation of suppressing the vibration of the gimbal can include reducing a gain of a speed loop of the gimbal. FIG. 11 is a schematic diagram of an example gimbal control system consistent with the disclosure. As shown in FIG. 11, the gimbal control system can include a three-loop control system having a position loop, the speed loop, and a current loop (not shown in FIG. 11). When the vibration frequency of the gimbal is in the first frequency range, for example, the vibration frequency of the gimbal is in the frequency range of 0 to 100 Hz, the gain of the speed loop in the gimbal control system can be reduced. For example, the gain of a feedback controller in the speed loop can be reduced. By reducing the gain of the speed loop, for example, reducing the gain of the feedback controller in the speed loop, the vibration of the gimbal in the first frequency range can be effectively reduced.

In some embodiments, a gain change amount can be determined according to the inertia moment of the payload carried by the gimbal. Reducing the gain of the speed loop of the gimbal can include reducing the gain of the speed loop according to the gain change amount. The gain of the speed loop of the gimbal can be reduced according to the gain change amount, and the gain change amount can be determined according to the inertia moment of the payload. For example, for the payloads having different weights carried by the same gimbal, the gain change amount can be different. In a working cycle of the gimbal, after determining the vibration frequency of the gimbal, a current gain of the speed loop can be obtained by reducing an original gain of the speed loop by the gain change amount. The gimbal can be controlled based on the current gain of the speed loop. In the next working cycle, the state information of the gimbal can be obtained, the frequency domain transformation can be performed on the state information to obtain the frequency domain data, and the amplitudes in the frequency domain data can be compared with the amplitude threshold using the manner described above. The vibration frequency of the gimbal determined according to the amplitude greater than or equal to the amplitude threshold in the frequency domain data can be determined as the vibration frequency of the gimbal. If the vibration frequency is in the first frequency range, the current gain of the speed loop can be obtained by reducing the original gain of the speed loop by the gain change amount, and the gimbal can be controlled based on the current gain of the speed loop. The original gain of the speed loop refers to a current gain of the speed loop obtained in a previous working cycle. The processes described above can be repeated until the amplitudes of the first frequency range in the frequency domain data are less than the amplitude threshold.

In some embodiments, the method can further include reducing a gain of the position loop of the gimbal. After determining the vibration frequency of the gimbal, the processor of the gimbal can determine that the vibration frequency is in the first frequency range. On the basis of reducing the gain of the speed loop of the gimbal, the gain of the position loop of the gimbal can further be reduced, such that the vibration of the gimbal in the first frequency range can be quickly suppressed. The method of reducing the gain of the position loop of the gimbal is similar to the method of reducing the gain of the speed loop of the gimbal, and detailed description thereof is omitted herein.

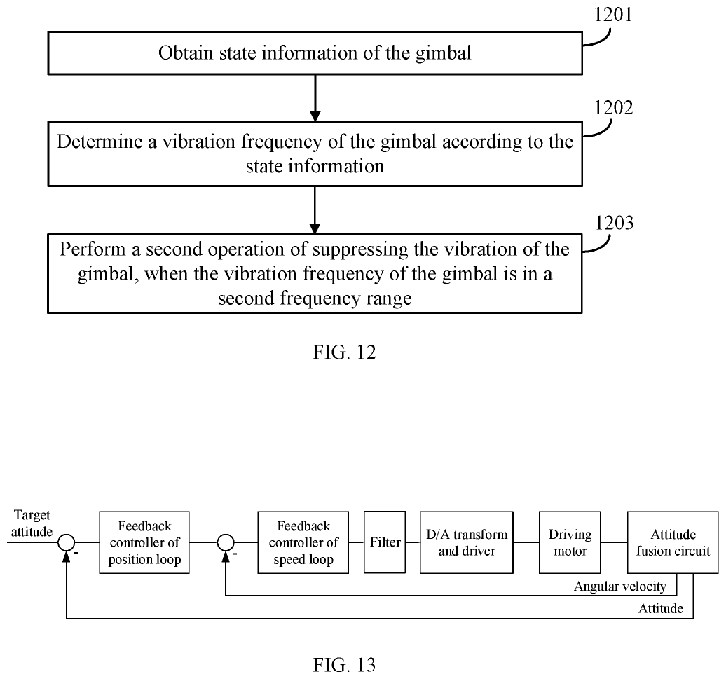

FIG. 12 is a schematic flow chart of another method for suppressing vibration of gimbal consistent with the disclosure. As shown in FIG. 12, at S1201, the state information of the gimbal is obtained. The implementation of the process at S1201 is similar to the implementation of the process at S201, and detailed description thereof is omitted herein.

At S1202, the vibration frequency of the gimbal is determined according to the state information. The implementation of the process at S1202 is similar to the implementation of the process at S202, or the processes at S302 and S303, and detailed description thereof is omitted herein.

At 51203, when the vibration frequency of the gimbal is in a second frequency range, a second operation of suppressing the vibration of the gimbal is performed. After determining the vibration frequency of the gimbal, the processor of the gimbal can determine whether the vibration frequency is in the second frequency range, i.e., determine whether the vibration frequency is in the second frequency band. When the vibration frequency is determined to be in the second frequency range, an operation corresponding to the second frequency range to suppress the vibration of the gimbal can be performed, i.e., the second operation. In some embodiments, the second frequency range may be defined as a high frequency band in the working frequency of the gimbal. In some embodiments, the second operation can be different from the first operation. When the vibration frequency of the gimbal is in the second frequency range, performing the second operation of suppressing the vibration of the gimbal may include, when the vibration frequency of the gimbal is greater than or equal to a second frequency threshold, performing the second operation of suppressing the vibration of the gimbal. The first frequency threshold and the second frequency threshold may be the same or may be different.

In some embodiments, performing the second operation of suppressing the vibration of the gimbal can include configuring a filter according to the vibration frequency of the gimbal, filtering a control amount of the driving motor using the filter, and controlling the driving motor of the gimbal using the filtered control amount. FIG. 13 is a schematic diagram of configuring the filter according to the vibration frequency of the gimbal consistent with the disclosure. As shown in FIG. 13, the gimbal control system can include the three-loop control system having the position loop, the speed loop, and the current loop (not shown in FIG. 13). When the vibration frequency of the gimbal is in the second frequency range, for example, when the vibration frequency of the gimbal is in the frequency range of 100 to 1000 Hz or when the vibration frequency of the gimbal is greater than or equal to 100 Hz, the filter can be configured according to the vibration frequency of the gimbal. The filter may include a digital filter. The control amount of the driving motor can be filtered using the filter. The control amount of the driving motor may include a control amount outputted by the feedback controller of the speed loop. The filter can effectively filter out a control component whose frequency is the vibration frequency of the gimbal in the control amount. The filtered control amount can be used to control the driving motor of the gimbal, which can effectively reduce the vibration of the gimbal in the second frequency range.

In some embodiments, the filter can include at least one of a notch filter, a band stop filter, or a low-pass filter. The type of the filter can be determined according to a frequency bandwidth of the vibration frequency of the gimbal.

In some embodiments, configuring the filter according to the vibration frequency of the gimbal can include, when the frequency bandwidth of the vibration frequency is less than or equal to a first frequency bandwidth threshold, configuring a notch filter according to the vibration frequency of the gimbal. After the vibration frequency of the gimbal is determined, the frequency bandwidth of the vibration frequency of the gimbal can be further determined. When the frequency bandwidth of the vibration frequency of the gimbal is small, for example, when it is less than or equal to the first frequency bandwidth threshold, the notch filter may be configured according to the vibration frequency of the gimbal. The control component with a small frequency bandwidth in the control amount of the drive motor can be precisely filtered out, which can effectively reduce the vibration of the gimbal at the vibration frequency.

In some embodiments, configuring the filter according to the vibration frequency of the gimbal can include, when the frequency bandwidth of the vibration frequency is greater than or equal to a second frequency bandwidth threshold, and is less than or equal to a third frequency bandwidth threshold, configuring a band stop filter according to the vibration frequency of the gimbal. After the vibration frequency of the gimbal is determined, the frequency bandwidth of the vibration frequency of the gimbal can be further determined. When the frequency bandwidth of the vibration frequency of the gimbal is great than or equal to the second frequency bandwidth threshold, and is less than or equal to the third frequency bandwidth threshold, the band stop filter may be configured according to the vibration frequency of the gimbal. The control component with the corresponding frequency band bandwidth in the control amount of the drive motor can be precisely filtered out, which can effectively reduce the vibration of the gimbal at the vibration frequency.

In some embodiments, configuring the filter according to the vibration frequency of the gimbal can include, when the frequency bandwidth of the vibration frequency is greater than or equal to a fourth frequency bandwidth threshold, configuring a low-pass filter according to the vibration frequency of the gimbal. After the vibration frequency of the gimbal is determined, the frequency bandwidth of the vibration frequency of the gimbal can be further determined. When the frequency bandwidth of the vibration frequency of the gimbal is great than or equal to a fourth frequency bandwidth threshold, the low-pass filter may be configured according to the vibration frequency of the gimbal. The control component with a large frequency bandwidth in the control amount of the drive motor can be precisely filtered out, which can effectively reduce the vibration of the gimbal at the vibration frequency.

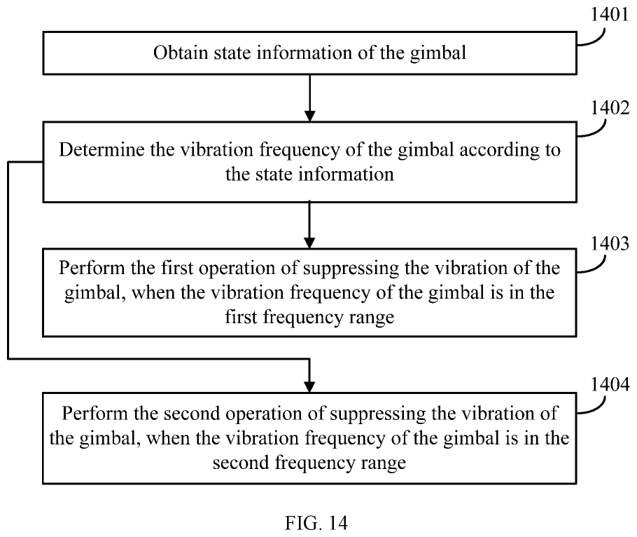

FIG. 14 is a schematic flow chart of another example method for suppressing vibration of gimbal consistent with the disclosure. The vibration may include a self-excited vibration. As shown in FIG. 14, at S1401, the state information of the gimbal is obtained. The implementation of the process at S1401 is similar to the implementation of the process at S201, and detailed description thereof is omitted herein.

At S1402, the vibration frequency of the gimbal is determined according to the state information. The implementation of the process at S1402 is similar to the implementation of the process at S202, or the processes at S302 and S303, and detailed description thereof is omitted herein.

At S1403, when the vibration frequency of the gimbal is in the first frequency range, the first operation of suppressing the vibration of the gimbal is performed.

At S1404, when the vibration frequency of the gimbal is in the second frequency range, the second operation of suppressing the vibration of the gimbal is performed. The first operation can be different from the second operation.

After determining the vibration frequency of the gimbal, whether the vibration frequency is in the first frequency range or the second frequency range can be determined. When the vibration frequency of the gimbal is in the first frequency range, the first operation of suppressing the vibration of the gimbal can be performed. When the vibration frequency of the gimbal is in the second frequency range, the second operation of suppressing the vibration of the gimbal can be performed. The first operation can be different from the second operation. That is, when the vibration frequency of the gimbal is in different frequency ranges, different operations for suppressing the vibration of the gimbal can be performed. As such, according to the specific situation of the vibration of the gimbal, an operation for suppressing the vibration of the gimbal that matches the vibration frequency of the gimbal can be selected to perform, thereby improving the effect of suppressing the vibration of the gimbal.

Consistent with the disclosure, the vibration frequency of the gimbal can be determined by the state information of the gimbal. When the vibration frequency of the gimbal is in the first frequency range, the first operation of suppressing the vibration of the gimbal can be performed. When the vibration frequency of the gimbal is in the second frequency range, the second operation of suppressing the vibration of the gimbal can be performed. As such, the operation for suppressing the vibration of the gimbal that matches the vibration frequency of the gimbal can be selected to perform, thereby accurately suppressing the vibration of the gimbal at different frequencies and improving the working state of the gimbal.

In some embodiments, the state information of the gimbal may include one or more of the angular acceleration, angular velocity, attitude information, and joint angle of the gimbal. In some embodiments, obtaining the state information of the gimbal can include obtaining the angular acceleration of the gimbal.

In some embodiments, determining the vibration frequency of the gimbal according to the state information can include determining the vibration frequency of the gimbal according to the angular acceleration data. In some embodiments, obtaining the angular acceleration of the gimbal can include obtaining the angular acceleration of the gimbal according to the gyroscope arranged at the gimbal. In some embodiments, obtaining the angular acceleration of the gimbal can include obtaining the joint angle of the gimbal, and determining the angular acceleration of the gimbal according to the joint angle.

In some embodiments, determining the vibration frequency of the gimbal according to the state information can include performing the frequency domain transformation on the state information to obtain the frequency domain data corresponding to the state information, and determining the vibration frequency of the gimbal according to the frequency domain data and the amplitude threshold.

In some embodiments, determining the vibration frequency of the gimbal according to the frequency domain data and the amplitude threshold can include determining the amplitude greater than or equal to the amplitude threshold in the frequency domain data, and determining the frequency corresponding to the amplitude as the vibration frequency of the gimbal.

In some embodiments, the amplitude threshold can be determined according to the frequency band. In some embodiments, the amplitude threshold can be determined according to the inertia moment of the payload carried by the gimbal.

In some embodiments, performing the first operation of suppressing the vibration of the gimbal can include reducing the gain of the speed loop of the gimbal. In some embodiments, the method can further include determining the gain change amount according to the inertia moment of the payload carried by the gimbal. In some embodiments, reducing the gain of the speed loop of the gimbal can include reducing the gain of the speed loop according to the gain change amount.

In some embodiments, the first operation of suppressing the vibration of the gimbal can further include reducing the gain of the position loop of the gimbal.

In some embodiments, performing the second operation of suppressing the vibration of the gimbal can include configuring the filter according to the vibration frequency of the gimbal, filtering the control amount of the driving motor using the filter, and controlling the driving motor of the gimbal using the filtered control amount. In some embodiments, the filter can include at least one of the notch filter, the band stop filter, or the low-pass filter.

In some embodiments, configuring the filter according to the vibration frequency of the gimbal can include, when the frequency bandwidth of the vibration frequency is less than or equal to the first frequency bandwidth threshold, configuring the notch filter according to the vibration frequency of the gimbal.

In some embodiments, configuring the filter according to the vibration frequency of the gimbal can include, when the frequency bandwidth of the vibration frequency is greater than or equal to the second frequency bandwidth threshold, and is less than or equal to the third frequency bandwidth threshold, configuring the band stop filter according to the vibration frequency of the gimbal.

In some embodiments, configuring the filter according to the vibration frequency of the gimbal can include, when the frequency bandwidth of the vibration frequency is greater than or equal to the fourth frequency bandwidth threshold, configuring the low-pass filter according to the vibration frequency of the gimbal.

The specific principles and implementations of the method are similar to those of the methods described above in connection with FIGS. 2, 3, 10, and 12, and detailed description thereof is omitted herein.

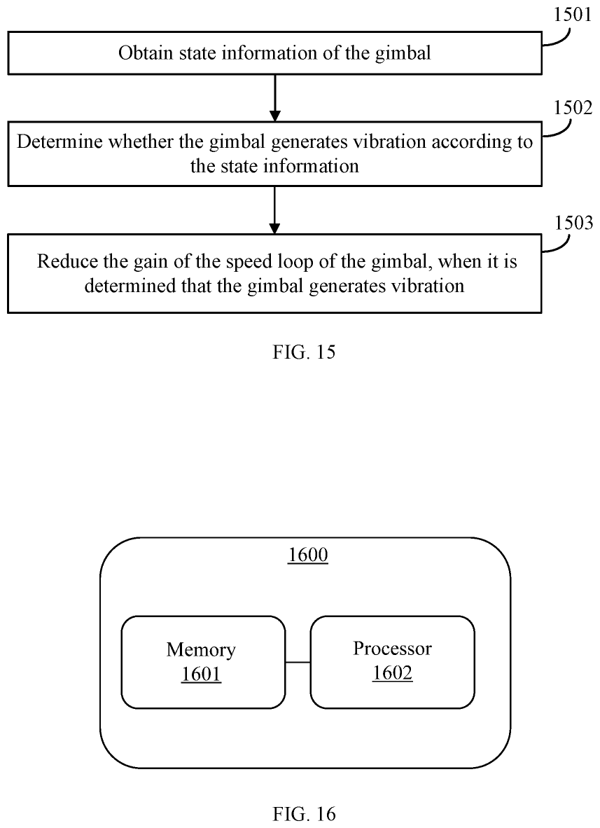

FIG. 15 is a schematic flow chart of another example method for suppressing vibration of gimbal consistent with the disclosure. The vibration may include a self-excited vibration. As shown in FIG. 15, at S1501, the state information of the gimbal is obtained. The implementation of the process at S1501 is similar to the implementation of the process at S201, and detailed description thereof is omitted herein.

At S1502, whether the gimbal generates vibration is determined according to the state information. The state information of the gimbal can reflect the working status of the gimbal. Therefore, whether the current gimbal generates vibration can be determined, by the processor of the gimbal, according to the state information of the gimbal.

At S1503, when it is determined that the gimbal generates vibration, the gain of the speed loop of the gimbal is reduced. When it is determined that the gimbal is vibrating, the processor of the gimbal can reduce the gain of the speed loop of the gimbal. By reducing the gain of the speed loop, the vibration of the gimbal can be effectively reduced.

In some embodiments, the state information of the gimbal may include one or more of the angular acceleration, angular velocity, attitude information, and joint angle of the gimbal. In some embodiments, obtaining the state information of the gimbal can include obtaining the angular acceleration of the gimbal.

In some embodiments, determining whether the gimbal generates vibration according to the state information can include determining whether the gimbal generates vibration according to the angular acceleration data. In some embodiments, obtaining the angular acceleration of the gimbal can include obtaining the angular acceleration of the gimbal according to the gyroscope arranged at the gimbal. In some embodiments, obtaining the angular acceleration of the gimbal can include obtaining the joint angle of the gimbal, and determining the angular acceleration of the gimbal according to the joint angle.

In some embodiments, determining whether the gimbal generates vibration according to the state information can include performing the frequency domain transformation on the state information to obtain the frequency domain data corresponding to the state information, and determining whether the gimbal generates vibration according to the frequency domain data and the amplitude threshold.

In some embodiments, determining whether the gimbal generates vibration according to the frequency domain data and the amplitude threshold can include, determining whether there is any amplitude greater than or equal to the amplitude threshold in the frequency domain data, and if yes, determining that the gimbal generates vibration.

In some embodiments, the method can further include determining the gain change amount according to the inertia moment of the payload carried by the gimbal. In some embodiments, reducing the gain of the speed loop of the gimbal can include reducing the gain of the speed loop according to the gain change amount. In some embodiments, performing the first operation of suppressing the vibration of the gimbal can further include reducing the gain of the position loop of the gimbal.

The specific principles and implementations of the method are similar to those of the methods described above in connection with FIGS. 2, 3, 10, 12, and 14, and detailed description thereof is omitted herein.

The present disclosure further provides a gimbal. FIG. 16 is a schematic structural diagram of an example gimbal 1600 consistent with the disclosure. As shown in FIG. 16, the gimbal 1600 includes a memory 1601 and a processor 1602.

The memory 1601 can be configured to store program instructions. The processor 1602 can be configured to call the program instructions. The program instructions, when being executed, cause the processor 1602 to obtain the state information of the gimbal, determine the vibration frequency of the gimbal according to the state information, and perform the operation of suppressing the vibration of the gimbal according to the vibration frequency of the gimbal. In some embodiments, the state information of the gimbal may include one or more of the angular acceleration, angular velocity, attitude information, and joint angle of the gimbal.

In some embodiments, when obtaining the state information of the gimbal, the processor 1602 can obtain the angular acceleration of the gimbal. When determining the vibration frequency of the gimbal according to the state information, the processor 1602 can determine the vibration frequency of the gimbal according to the angular acceleration data.

When obtaining the angular acceleration of the gimbal, the processor 1602 can obtain the angular acceleration of the gimbal according to the gyroscope arranged at the gimbal. When obtaining the angular acceleration of the gimbal, the processor 1602 can obtain the joint angle of the gimbal, and determine the angular acceleration of the gimbal according to the joint angle.

In some embodiments, when determining the vibration frequency of the gimbal according to the state information, the processor 1602 can perform the frequency domain transformation on the state information to obtain the frequency domain data corresponding to the state information, and determine the vibration frequency of the gimbal according to the frequency domain data and the amplitude threshold.

In some embodiments, when determining the vibration frequency of the gimbal according to the frequency domain data and the amplitude threshold, the processor 1602 can determine the amplitude greater than or equal to the amplitude threshold in the frequency domain data, and determine the frequency corresponding to the amplitude as the vibration frequency of the gimbal.

In some embodiments, the amplitude threshold can be determined according to the frequency band. In some embodiments, the amplitude threshold can be determined according to the inertia moment of the payload carried by the gimbal.

In some embodiments, when performing the operation of suppressing the vibration of the gimbal according to the vibration frequency of the gimbal, the processor 1602 can, when the vibration frequency of the gimbal is in the first frequency range, perform the first operation of suppressing the vibration of the gimbal.

In some embodiments, when performing the first operation of suppressing the vibration of the gimbal, the processor 1602 can reduce the gain of the speed loop of the gimbal. In some embodiments, the processor 1602 can be further configured to determine the gain change amount according to the inertia moment of the payload carried by the gimbal. When reducing the gain of the speed loop of the gimbal, the processor 1602 can reduce the gain of the speed loop according to the gain change amount.

In some embodiments, when reducing the gain of the speed loop of the gimbal, the processor 1602 can reduce the gain of the position loop of the gimbal.

In some embodiments, when performing the operation of suppressing the vibration of the gimbal according to the vibration frequency of the gimbal, the processor 1602 can, when the vibration frequency of the gimbal is in the second frequency range, perform the second operation of suppressing the vibration of the gimbal. In some embodiments, when performing the second operation of suppressing the vibration of the gimbal, the processor 1602 can configure the filter according to the vibration frequency of the gimbal, filter the control amount of the driving motor using the filter, and control the driving motor of the gimbal using the filtered control amount. In some embodiments, the filter can include at least one of the notch filter, the band stop filter, or the low-pass filter.

In some embodiments, when configuring the filter according to the vibration frequency of the gimbal, the processor 1602 can, when the frequency bandwidth of the vibration frequency is less than or equal to the first frequency bandwidth threshold, configure the notch filter according to the vibration frequency of the gimbal.

In some embodiments, when configuring the filter according to the vibration frequency of the gimbal, the processor 1602 can, when the frequency bandwidth of the vibration frequency is greater than or equal to the second frequency bandwidth threshold, and is less than or equal to the third frequency bandwidth threshold, configure the band stop filter according to the vibration frequency of the gimbal.

In some embodiments, when configuring the filter according to the vibration frequency of the gimbal, the processor 1602 can, when the frequency bandwidth of the vibration frequency is greater than or equal to the fourth frequency bandwidth threshold, configure the low-pass filter according to the vibration frequency of the gimbal.

The specific principles and implementations of the method are similar to those of the methods described above in connection with FIGS. 2, 3, 10, and 12, and detailed description thereof is omitted herein.

The present disclosure further provides another gimbal. As shown in FIG. 16, the gimbal 1600 includes the memory 1601 and the processor 1602. The memory 1601 can be configured to store program instructions. The processor 1602 can be configured to call the program instructions. The program instructions, when being executed, cause the processor 1602 to obtain the state information of the gimbal, determine the vibration frequency of the gimbal according to the state information, when the vibration frequency of the gimbal is in the first frequency range, perform the first operation of suppressing the vibration of the gimbal, and when the vibration frequency of the gimbal is in the second frequency range, perform the second operation of suppressing the vibration of the gimbal. The first operation can be different from the second operation. In some embodiments, the state information of the gimbal may include one or more of the angular acceleration, angular velocity, attitude information, and joint angle of the gimbal.

In some embodiments, when obtaining the state information of the gimbal, the processor 1602 can be configured to obtain the angular acceleration of the gimbal. When determining the vibration frequency of the gimbal according to the state information, the processor 1602 can determine the vibration frequency of the gimbal according to the angular acceleration data.

When obtaining the angular acceleration of the gimbal, the processor 1602 can obtain the angular acceleration of the gimbal according to the gyroscope arranged at the gimbal. When obtaining the angular acceleration of the gimbal, the processor 1602 can obtain the joint angle of the gimbal, and determine the angular acceleration of the gimbal according to the joint angle.

In some embodiments, when determining the vibration frequency of the gimbal according to the state information, the processor 1602 can perform the frequency domain transformation on the state information to obtain the frequency domain data corresponding to the state information, and determine the vibration frequency of the gimbal according to the frequency domain data and the amplitude threshold.

In some embodiments, when determining the vibration frequency of the gimbal according to the frequency domain data and the amplitude threshold, the processor 1602 can determine the amplitude greater than or equal to the amplitude threshold in the frequency domain data, and determine the frequency corresponding to the amplitude as the vibration frequency of the gimbal.

In some embodiments, the amplitude threshold can be determined according to the frequency band. In some embodiments, the amplitude threshold can be determined according to the inertia moment of the payload carried by the gimbal.

In some embodiments, when performing the first operation of suppressing the vibration of the gimbal, the processor 1602 can reduce the gain of the speed loop of the gimbal. In some embodiments, the processor 1602 can be further configured to determine the gain change amount according to the inertia moment of the payload carried by the gimbal. When reducing the gain of the speed loop of the gimbal, the processor 1602 can reduce the gain of the speed loop according to the gain change amount.

In some embodiments, when reducing the gain of the speed loop of the gimbal, the processor 1602 can further reduce the gain of the position loop of the gimbal.

In some embodiments, when performing the operation of suppressing the vibration of the gimbal according to the vibration frequency of the gimbal, the processor 1602 can, when the vibration frequency of the gimbal is in the second frequency range, perform the second operation of suppressing the vibration of the gimbal. In some embodiments, when performing the second operation of suppressing the vibration of the gimbal, the processor 1602 can configure the filter according to the vibration frequency of the gimbal, filter the control amount of the driving motor using the filter, and control the driving motor of the gimbal using the filtered control amount. In some embodiments, the filter can include at least one of the notch filter, the band stop filter, or the low-pass filter.

In some embodiments, when configuring the filter according to the vibration frequency of the gimbal, the processor 1602 can, when the frequency bandwidth of the vibration frequency is less than or equal to the first frequency bandwidth threshold, configure the notch filter according to the vibration frequency of the gimbal.

In some embodiments, when configuring the filter according to the vibration frequency of the gimbal, the processor 1602 can, when the frequency bandwidth of the vibration frequency is greater than or equal to the second frequency bandwidth threshold, and is less than or equal to the third frequency bandwidth threshold, configure the band stop filter according to the vibration frequency of the gimbal.

In some embodiments, when configuring the filter according to the vibration frequency of the gimbal, the processor 1602 can, when the frequency bandwidth of the vibration frequency is greater than or equal to the fourth frequency bandwidth threshold, configure the low-pass filter according to the vibration frequency of the gimbal.

The specific principles and implementations of the method are similar to those of the methods described above in connection with FIGS. 2, 3, 10, 12, and 14, and detailed description thereof is omitted herein.

The present disclosure further provides another gimbal. As shown in FIG. 16, the gimbal 1600 includes the memory 1601 and the processor 1602. The memory 1601 can be configured to store program instructions. The processor 1602 can be configured to call the program instructions. The program instructions, when being executed, cause the processor 1602 to obtain the state information of the gimbal, determine whether the gimbal generates vibration according to the state information, and when it is determined that the gimbal generates vibration, reduce the gain of the speed loop of the gimbal.

In some embodiments, the state information of the gimbal may include one or more of the angular acceleration, angular velocity, attitude information, and joint angle of the gimbal. In some embodiments, when obtaining the state information of the gimbal, the processor 1602 can obtain the angular acceleration of the gimbal. When determining whether the gimbal generates vibration according to the state information, the processor 1602 can determine whether the gimbal generates vibration according to the angular acceleration data.

In some embodiments, when obtaining the angular acceleration of the gimbal, the processor 1602 can obtain the angular acceleration of the gimbal according to the gyroscope arranged at the gimbal. In some embodiments, when obtaining the angular acceleration of the gimbal, the processor 1602 can obtain the joint angle of the gimbal, and determine the angular acceleration of the gimbal according to the joint angle.

In some embodiments, when determining whether the gimbal generates vibration according to the state information, the processor 1602 can perform the frequency domain transformation on the state information to obtain the frequency domain data corresponding to the state information, and determine whether the gimbal generates vibration according to the frequency domain data and the amplitude threshold.

In some embodiments, when determining whether the gimbal generates vibration according to the frequency domain data and the amplitude threshold, the processor 1602 can determine whether there is any amplitude greater than or equal to the amplitude threshold in the frequency domain data, and if yes, determine that the gimbal generates vibration.

In some embodiments, the processor 1602 can be further configured to determine the gain change amount according to the inertia moment of the payload carried by the gimbal. In some embodiments, when reducing the gain of the speed loop of the gimbal, the processor 1602 can reduce the gain of the speed loop according to the gain change amount.

In some embodiments, when performing the first operation of suppressing the vibration of the gimbal, the processor 1602 can further reduce the gain of the position loop of the gimbal.

The specific principles and implementations of the method are similar to those of the methods described above in connection with FIGS. 2, 3, 10, 12, 14, and 15, and detailed description thereof is omitted herein.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A method for suppressing a vibration of a gimbal comprising:
obtaining state information of the gimbal;
determining a vibration frequency of the gimbal according to the state information; and
performing an operation of suppressing the vibration of the gimbal according to the vibration frequency of the gimbal.

2. The method of claim 1, wherein the state information includes one or more of an angular acceleration, an angular velocity, attitude information, and a joint angle of the gimbal.

3. The method of claim 1, wherein:
obtaining the state information of the gimbal includes obtaining an angular acceleration of the gimbal; and
determining the vibration frequency of the gimbal according to the state information includes determining the vibration frequency of the gimbal according to the angular acceleration.

4. The method of claim 3, wherein obtaining the angular acceleration of the gimbal includes obtaining the angular acceleration of the gimbal through a gyroscope arranged at the gimbal.

5. The method of claim 3, wherein obtaining the angular acceleration of the gimbal includes:
obtaining a joint angle of the gimbal; and
determining the angular acceleration of the gimbal according to the joint angle.

6. The method of claim 1, wherein determining the vibration frequency of the gimbal according to the state information includes:
performing frequency domain transformation on the state information to obtain frequency domain data corresponding to the state information; and
determining the vibration frequency of the gimbal according to the frequency domain data and an amplitude threshold.

7. The method of claim 6, wherein determining the vibration frequency of the gimbal according to the frequency domain data and the amplitude threshold includes:
determining an amplitude greater than or equal to the amplitude threshold in the frequency domain data; and
determining the frequency corresponding to the amplitude as the vibration frequency of the gimbal.

8. The method of claim 6, wherein the amplitude threshold is determined according to a frequency band.

9. The method of claim 6, wherein the amplitude threshold is determined according to an inertia moment of a payload carried by the gimbal.

10. The method of claim 1, wherein performing the operation of suppressing the vibration of the gimbal includes performing an operation of suppressing the vibration of the gimbal in response to the vibration frequency of the gimbal being in a frequency range.

11. The method of claim 10, wherein performing the operation of suppressing the vibration of the gimbal includes reducing a gain of a speed loop of the gimbal.

12. The method of claim 11, further comprising:
determining a gain change amount according to an inertia moment of a payload carried by the gimbal;
wherein reducing the gain of the speed loop of the gimbal includes reducing the gain of the speed loop according to the gain change amount.

13. The method of claim 11, wherein performing the first operation of suppressing the vibration of the gimbal further includes reducing a gain of a position loop of the gimbal.

14. The method of claim 10, wherein performing the operation of suppressing the vibration of the gimbal includes:
configuring a filter according to the vibration frequency of the gimbal;
filtering a control amount of a driving motor of the gimbal using the filter; and
controlling the driving motor using the filtered control amount.

15. The method of claim 14, wherein the filter includes at least one of a notch filter, a band stop filter, or a low-pass filter.

16. The method of claim 14, wherein configuring the filter according to the vibration frequency of the gimbal includes configuring a notch filter according to the vibration frequency of the gimbal in response to a frequency bandwidth of the vibration frequency being less than or equal to a frequency bandwidth threshold.

17. The method of claim 14, wherein configuring the filter according to the vibration frequency of the gimbal includes configuring a band stop filter according to the vibration frequency of the gimbal in response to a frequency bandwidth of the vibration frequency being greater than or equal to a first frequency bandwidth threshold and less than or equal to a second frequency bandwidth threshold.

18. The method of claim 14, wherein configuring the filter according to the vibration frequency of the gimbal includes configuring a low-pass filter according to the vibration frequency of the gimbal in response to a frequency bandwidth of the vibration frequency being greater than or equal to a frequency bandwidth threshold.

19. The method of claim 14, wherein configuring the filter according to the vibration frequency of the gimbal includes:
configuring a notch filter according to the vibration frequency of the gimbal in response to a frequency bandwidth of the vibration frequency being less than or equal to a first frequency bandwidth threshold;
configuring a band stop filter according to the vibration frequency of the gimbal in response to the frequency bandwidth of the vibration frequency being greater than or equal to a second frequency bandwidth threshold and less than or equal to a third frequency bandwidth threshold; and
configuring a low-pass filter according to the vibration frequency of the gimbal in response to the frequency bandwidth of the vibration frequency being greater than or equal to a fourth frequency bandwidth threshold.

20. A gimbal comprising:
a memory storing program instructions; and
a processor configured to execute the program instructions stored in the memory to:
obtain state information of the gimbal;
determine a vibration frequency of the gimbal according to the state information; and
perform an operation of suppressing a vibration of the gimbal according to the vibration frequency of the gimbal.
